(19) United States
(12) Patent Application Publication
(10) Pub. No.: US 2010/0188476 A1
(43) Pub. Date: Jul. 29, 2010

(54) Image Quality of Video Conferences

(75) Inventor: Mukund N. Thapa, Palo Alto, CA (US)

Correspondence Address: FENWICK & WEST LLP, SILICON VALLEY CENTER, 801 CALIFORNIA STREET, MOUNTAIN VIEW, CA, 94041, US

(73) Assignee: Optical Fusion Inc., Palo Alto, CA (US)

(21) Appl. No.: 12/692,802

(22) Filed: Jan. 25, 2010

Related U.S. Application Data
(60) Provisional application No. 61/148,343, filed on Jan. 29, 2009.
(60) Provisional application No. 61/172,132, filed on Apr. 23, 2009.

(51) Int. Cl. H04N 7/14

(52) U.S. Cl. 348/14.08; 348/E07.077

(57) ABSTRACT

A method (and corresponding system and computer program product) providing high image quality video conferences at low network bandwidth usage. Video images are captured at a high resolution and downsampled to a low resolution before transmitted over a network. When the downsampled video images are received, they are upconverted back to higher resolution video images. The upconverted video images are then transmitted to a display device via a High-Definition Multimedia Interface (HDMI) output, and displayed on the display device.

### CROSS REFERENCE TO RELATED APPLICATIONS

This application claims the benefit of U.S. Provisional Application No. 61/148,343, “Video Conference With Improved Video Quality” by Mukund N. Thapa filed on Jan. 29, 2009, and also claims the benefit of U.S. Provisional Application No. 61/172,132, “Video Conference Improving Video Quality” by Mukund N. Thapa filed on Apr. 23, 2009, and both of which are incorporated by reference herein in their entirety.

### BACKGROUND OF THE INVENTION

1. Field of the Invention

The present invention relates generally to video conferencing over a network. In particular, the present invention is directed towards systems and methods for improving image quality of video conferences.

2. Description of Background Art

Conventional video conferencing technologies are generally cumbersome and unnatural for users. They can also require specialized equipment or connections, thus making the video conference expensive and limiting participation only to those who have the specialized equipment and connections. For example, it is not unusual for video conferencing capabilities within a company to be based on a specialized system. The company spends a significant amount of money to purchase a limited number of specialized video conferencing equipment. This equipment is set up by the company's IT staff in specific rooms that support video conferencing. Groups who desire to have a video conference then book these rooms in advance. Details of the video conference are given to the IT staff, who make the necessary preparations in advance. At the scheduled time and only at the scheduled time, the video conference takes place, if there are no problems. If there are problems, everyone waits around until IT fixes the problem. In addition, the video conferencing service may require access to special data networks, for which the company must pay additional fees.

In addition to the above restrictions, the image quality of the conventional video conferences is primarily determined by the network bandwidth and the special hardware used. For example, in order to have a high quality video conference, the conventional video conferencing technologies would consume substantial network bandwidth and use expensive custom hardware. If a user does not have access to wide network bandwidth, or cannot afford the custom hardware, then the image quality of that user's video conference would be very poor.

Thus, there is a need for additional video conferencing capabilities, including capabilities such as providing high quality video images at low network bandwidth usage.

### BRIEF DESCRIPTION OF THE DRAWINGS

FIG. 1 is a block diagram of a server-based architecture suitable for use with the invention.

FIGS. 2A-2I are a series of screen shots illustrating a process for a user to initiate a video conference.

### DETAILED DESCRIPTION OF THE PREFERRED EMBODIMENTS

### Overview

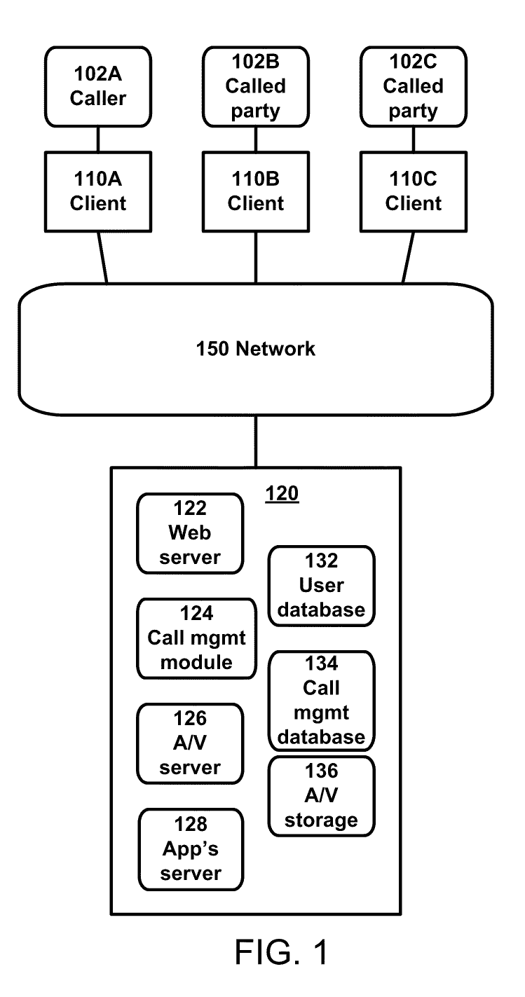

Embodiments of the present disclosure provide methods (and corresponding systems and computer program products) for operating open video conferences and delivering high image quality video conferences through low network bandwidth usage. The methods for operating open video conferences and delivering high image quality video conferences can be implemented through a server-based video conferencing architecture, an example of which is described in detail below with regard to FIG. 1. One skilled in the art would readily understand that the present disclosure is not restricted to this architecture, and can be implemented in other architectures such as peer-to-peer architecture.

### Architecture of a Multi-Point Multi-Person Video Conferencing System

FIG. 1 is a block diagram of a server-based video conferencing architecture for a multi-point multi-person video conferencing system suitable for use with the invention. In this example, a participant 102A desires to have a video conference with two other participants 102B,102C. For convenience, participant 102A will be referred to as the caller and participants 102B,102C as the called parties. The caller 102A initiates the video conference by making an initial video conference call to the called parties 102B,102C. The called parties 102B,102C join the video conference by accepting caller 102A's video conference call.

Each participant 102 is operating a client device 110, which connects via a network 150 to a central server 120. The network 150 may be a wired or wireless network. Examples of the network 150 include the Internet, an intranet, a WiFi network, a WiMAX network, a mobile telephone network, or a combination thereof. In this server-based architecture, the server 120 coordinates the set up and the tear down of the video conference. In this particular example, each client device 110 is a computer that runs client software with video conferencing capability. To allow full video and audio capability, each client device 110 includes a camera (for video capture), a display (for video play back), a microphone (for audio capture) and a speaker (for audio play back).

The client devices 110 are connected via the network 150 to the central server 120. In this example, the central server 120 includes a web server 122, a call management module 124, an audio/video server 126 and an applications server 128. The server 120 also includes user database 132, call management database 134 and audio/video storage 136. The participants 102 have previously registered and their records are stored in user database 132. The web server 122 handles the web interface to the client devices 110. The call management module 124 and call management database 134 manage the video conference calls, including the set up and tear down of video conferences. For example, the call management database 134 includes records of who is currently participating on which video conferences. It may also include records of who is currently logged in and available for video conference calls, their port information, and/or their video conferencing capabilities. The audio/video server 126 manages the audio streams, the video streams, and/or the text streams (collectively called media streams) for these video conferences. Streaming technologies, as well as other technologies, can be used. Storage of audio and video at the server is handled by audio/video storage 136. The application server 128 invokes other applications (not shown) as required.

### Process for Initiating a Video Conference

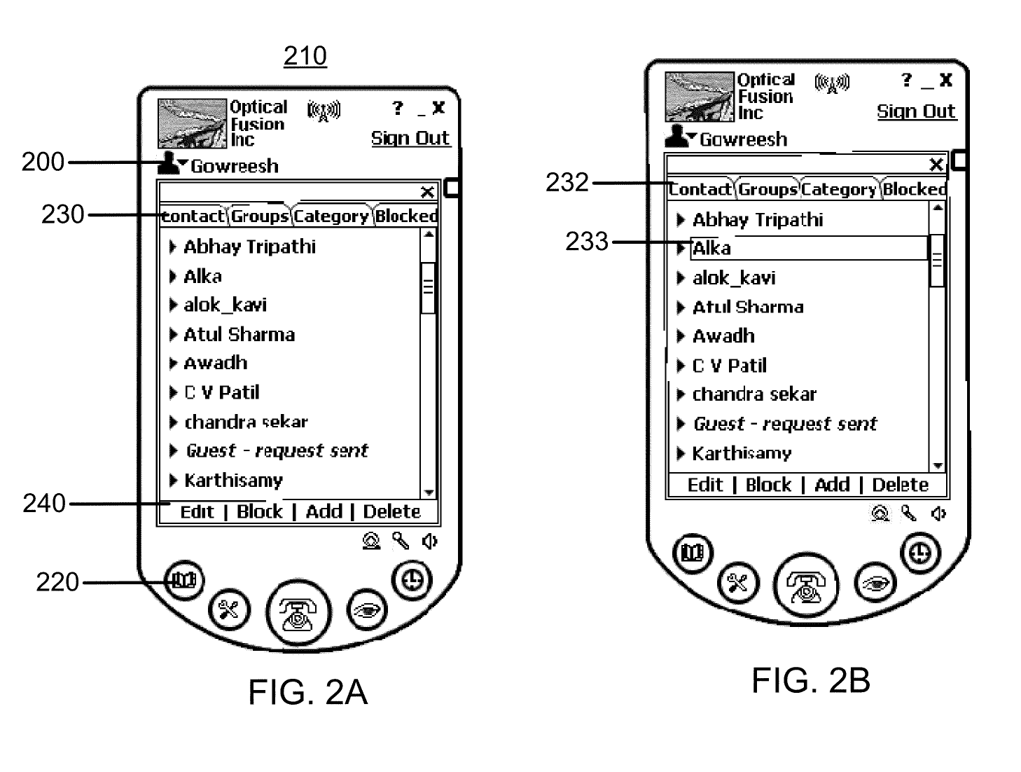

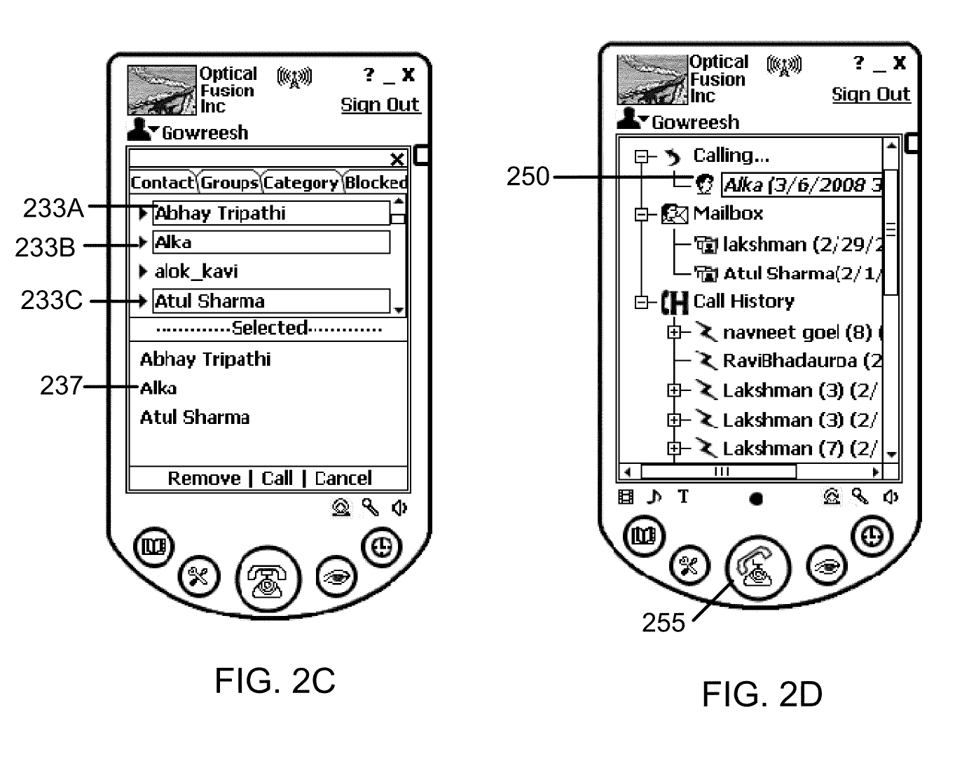

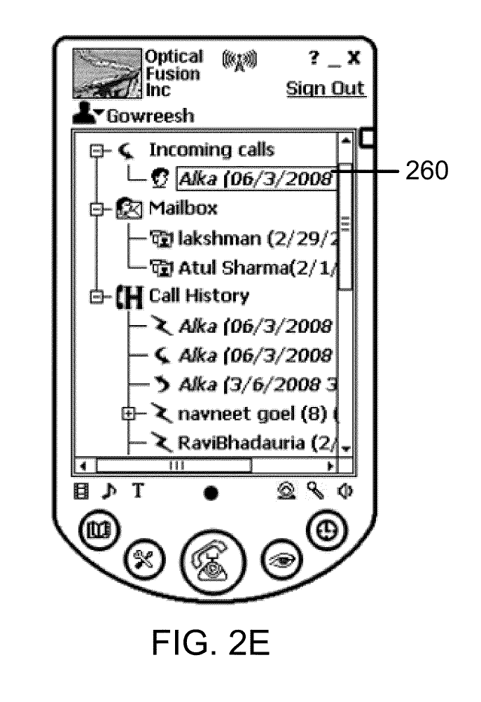

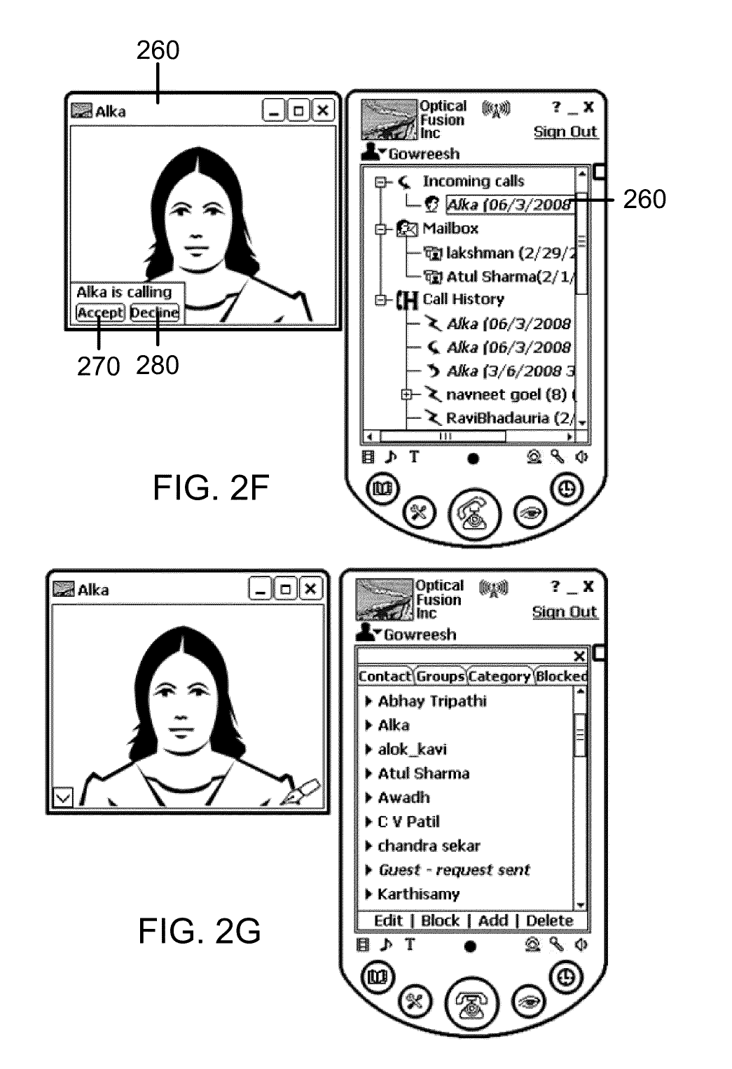

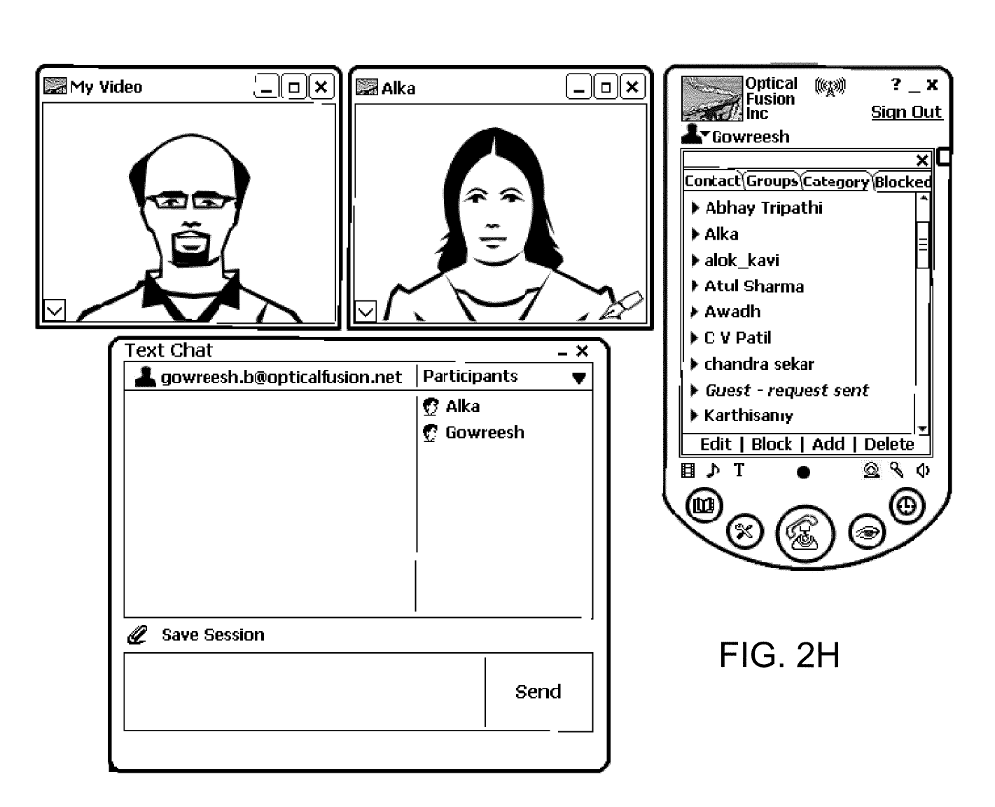

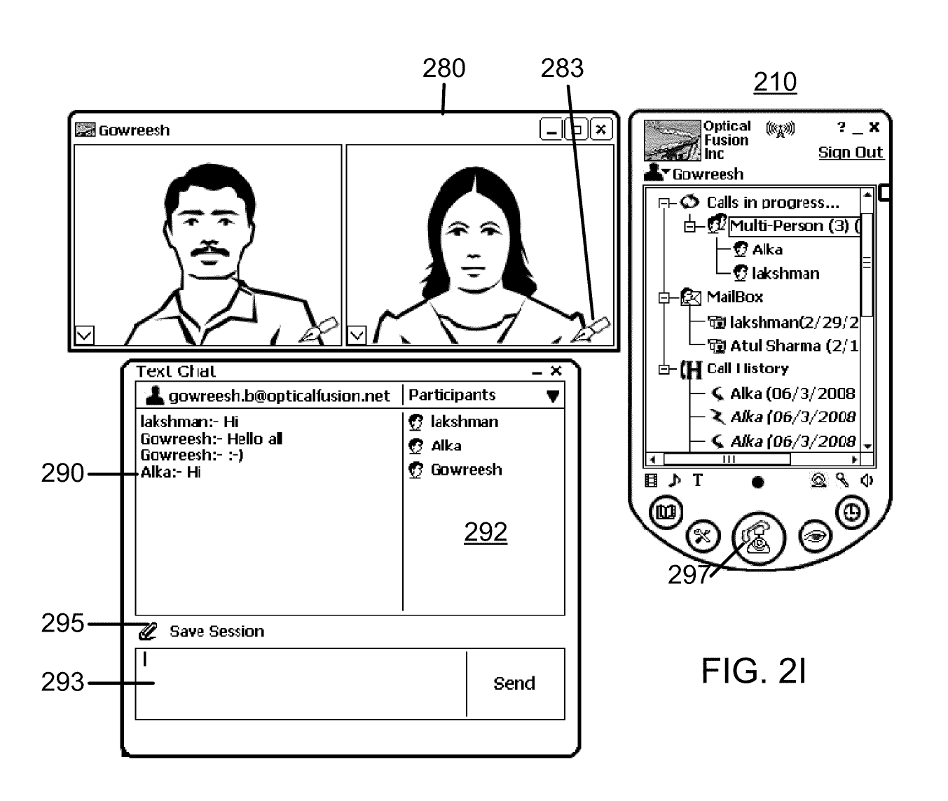

To begin the video conference initiation process, the caller 102A selects the other participants 102B,102C (also called “called parties”) for the video conference. In FIGS. 2B and 2C, the caller 102A selects the other participants 102B,102C from his address book (tab 232). In FIG. 2B, the caller 102A (Gowreesh) is selecting Alka 233, as shown by the highlighting of this contact. In FIG. 2C, the caller Gowreesh has selected multiple other participants: Abhay, Alka and Atul, as indicated by the highlighted contacts 233A,B,C. The currently selected participants are also shown in area 237. When the caller is finished selecting participants, the caller makes an initial video conference call, which sends the list of selected participants from client 110A to the server 120.

The caller 102A makes the initial video conference call by activating the call button 255, which is prominently placed due to its importance. FIG. 2D shows a screen shot where the caller's communicator 210 has an indication 250 that a video conference call is being placed to Alka. Naturally, although FIG. 2D shows a video conference call being placed only to Alka, the video conference call can be placed to more than one person at a time.

The server 120 begins to set up the video conference call by creating an entry for the new video conference in a conference table (also known as the call table) within the call management database 134. In one implementation, this entry includes a unique conference ID to identify the new video conference, possibly a conference name, a conference type (public, private, or hidden), and a conference administrative ID corresponding to the caller 102A. The server 120 also inserts the list of participant ID's into the conference entry, in this example implementation by use of a user table that includes conference ID, user ID, and A/V capability (e.g., audio, video and/or text). The server 120 obtains the IP address, login port number and session ID for participants from a table of logged in users, which may also be maintained as part of the call management database 134 (or the user database 132).

Assuming the called parties 102B,102C are logged on, the server 120 sends an initial request to their client devices 110B,110C. This could be in the form of a ring, for example. FIG. 2E shows a screen shot of a called party receiving notification 260 of an incoming video conference call. Note that, in this example, Gowreesh and Alka have changed roles. FIG. 2E still shows Gowreesh's communicator. However, Alka is the caller and Gowreesh is the called party. The communicator shows 260 that Alka is calling Gowreesh.

In FIG. 2F, the notification 260 also includes a window showing the caller. The called party can accept the video conference call and join the video conference by activating the accept button 270. Once the called party joins the video conference, the other participants 102 are made aware of his presence. At the server 120, the conference table is updated to include the participants 102 that accepted. As a result, the server 120 now routes the media streams (e.g., video, audio, and/or text) to and from the new participants 102.

FIGS. 2G-2I show screen shots of a video conference. In FIG. 2G, there is one other participant, Alka, in addition to the caller Gowreesh. FIG. 2H is an alternate interface that shows Gowreesh in addition to Alka. In FIG. 2I, a third participant Lakshman has joined the video conference. FIG. 2I shows the main communicator element 210, a video conference window 280 that shows both of the other participants, and a third window 290.

This ancillary window 290 displays a list of the current participants 102 and also provides for text chat. The participant's text chat is entered in area 293. Text chat can be shared between all participants or only between some participants (i.e., private conversations). The participant can initiate private communications or send private text messages by clicking on the pen icon. For example, Gowreesh's clicking on Alka's pen icon 283 establishes text chat between Alka and Gowreesh. In addition to text, files can also be shared by clicking on the attachment icon 295. Text chat and attachments can be saved.

Similarly, the called party can decline the video conference call by clicking the decline button 280, as shown in FIG. 2F. The corresponding client device 110 sends a notification to the server 120 reporting the declination. The server 120 updates the conference table and notifies the other participants 102 of the declination. When a called party declines the video conference call or is not logged in to the server 120, the server 120 can provide a videomail service to the caller. The caller can then leave a videomail message for the called party.

FIGS. 2A-2I illustrate one example, but the invention is not limited to these specifics. For example, the video conference can be previously scheduled by a participant 102 or a non-participating user. The server 120 initiates the scheduled video conference by sending an initial request to all scheduled participants 102 at the scheduled date and time. As another example, client devices 110 other than a computer running client software can be used. Examples include PDAs, mobile phones, web-enabled TV, and SIP phones and terminals (i.e., phone-type devices using the SIP protocol that typically have a small video screen and audio capability). In addition, not every client device 110 need have both audio and video and both input and output. Some participants 102 may participate with audio only or video only, or be able to receive but not send audio/video or vice versa. The underlying architecture also need not be server-based. It could be peer-to-peer, or a combination of server and peer-to-peer. For example, participants that share a local network may communicate with each other on a peer-to-peer basis, but communicate with other participants via a server. The underlying signaling protocol may be a proprietary protocol or a standard protocol such as Session Initiation Protocol (SIP). Other variations will be apparent.

### Process for Improving Image Quality

Current web cameras capture small frame sizes in low video quality. Later, when a zoom factor is applied, the image looks worse as expected. Such situations come up routinely in videoconferencing. Capture is done, for example, at 160×120, and the video is displayed at the other end at 320×240, and sometimes even in full screen mode. The resulting image is grainy and blurry, especially in full screen mode. Capturing at lower resolution has the advantage that in low broadband bandwidth, more data can be transmitted and at a higher frame rate.

Described below is a configuration that delivers high image quality video conferences at low network bandwidth usage. In one embodiment, the configuration utilizes three techniques to achieve this purpose: (1) downsampling video (from a high resolution to a low resolution) before transmitting the video, (2) upscaling the received video (from the low resolution back to a high resolution), and (3) outputting the upscaled video through an HDMI (High-Definition Multimedia Interface) output to an external device for high quality display. Each of these techniques are described in detail below. One of ordinary skill in the art will recognize that the techniques used in the configuration can also be used in conjunction with other digital imaging techniques to further improve video characteristics such as blurriness and sharpness.

### 1. Downsampling

In one embodiment, a camera of a client device 110 is configured to capture video (or image) at a high resolution. The captured video is then downsampled using an appropriate downsampling algorithm (such as Lanczos, Bicubic, Bspline, bilinear) to produce a higher quality smaller image than that would be obtained with a smaller frame size capture. Note that downsampling is also referred to as resampling.

Typically pictures at higher resolutions are captured with more detail. Careful downscaling preserves some of the additional detail. Thus, in most cases a downscaled image has higher quality than an image captured at a low resolution. Thus for example a 320×240 captured by a video camera and downsampled to 160×120 is clearer than capturing 160×120. An even better 160×120 image can be obtained by capturing an image at higher resolution (e.g., 640×480) and downsampling to 160×120.

Using this in a video conference call decreases the bandwidth requirement while maintaining quality as follows. Capture at a higher resolution (as high as suitable); next downsample to 160×120, then use any codec to compress it and send it to the other client(s). On the other end decompress and zoom the decompressed image. The quality is much superior to that obtained by simply capturing at 160×120, compressing, sending, decompressing, and zooming. The quality enhancement process is independent of the sending step or the particular compression algorithm used. In general, the better the source, the better will be the quality of the image after compression/decompression.

Thus, for example, when going into full screen mode, the image that was zoomed from a 160×120 obtained by downsampling is superior to that obtained by capturing a 160×120 image and zooming to full screen mode.

### 2. Upconversion

In one embodiment, an incoming video signal of a lower resolution is converted to one of a higher resolution. This technique (hereinafter called upconversion or upscaling), when applied to a video stream received in a videoconference call, improves the video (or image) quality when played back on a higher resolution monitor such as an HD monitor.

The decoded frame of a video conference is upscaled before zoomed or set to full screen mode on a monitor or TV. An upscaled image typically has higher quality than an image resulting from a simple zoom provided by the operating systems. When combined with the downsampling method described in the previous section, the system obtains a higher quality video display while utilizing lower bandwidth.

### 3. HDMI Output

In one embodiment, instead of (or in addition to) using custom hardware to obtain high quality video on a standard LCD or Plasma screen (and, in the future, on other technologies such as laser), the system uses existing hardware to provide a high quality video experience in limited bandwidth. And, of course, as bandwidth is increased, the system can take advantage of that to provide an even better experience.

The approach is to either use a laptop with HDMI (High-Definition Multimedia Interface) output, or a desktop with an HDMI out enabled graphics card. The HDMI output is attached to a large LCD/Plasma TV/monitor. When attaching via HDMI to a TV (or monitor with speakers), in addition to video, the sound is also enabled. This coupled with the techniques described in the previous sections provide an improved video call experience at low bandwidth usage.

Enhanced image quality can be achieved using some, or all of the above described techniques. For example, instead of displaying the video in an external monitor via HDMI, the video can be displayed on a laptop screen and/or on a computer monitor via any of the cabling methods.

The present invention has been described in particular detail with respect to a limited number of embodiments. One skilled in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CDs, DVDs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

I claim:

1. A computer-implemented method for open video conference calling, the method comprising:
capturing, by a video camera of a first party, an original video image at an original resolution;
generating, by a computing device of the first party, a second video image of a second resolution by downsampling the original video image, the second resolution being lower than the original resolution;
transmitting the second video image from the computing device of the first party to a computing device of a second party;
generating, by the computing device of the second party, a third video image of a third resolution by upconverting the second video image, the third resolution being higher than the second resolution;
outputting, by the computing device of the second party, the third video image to a display device through an High-Definition Multimedia Interface output; and
displaying, by the display device, the third video image.
